(19) United States
(12) Patent Application Publication
(10) Pub. No.: US 2021/0027320 A1
(43) Pub. Date: Jan. 28, 2021

(54) METHOD AND SYSTEM FOR GENERATING RETURN FORECASTS AND PORTFOLIO CONSTRUCTION

(71) Applicants: Gustavo Schwenkler, Medford, MA (US); Stephen Roux, Southbank (AU)

(72) Inventors: Gustavo Schwenkler, Medford, MA (US); Stephen Roux, Southbank (AU)

(21) Appl. No.: 16/939,911

(22) Filed: Jul. 27, 2020

Related U.S. Application Data
(63) Continuation of application No. 16/939,874, filed on Jul. 27, 2020.
(60) Provisional application No. 62/878,936, filed on Jul. 26, 2019.

(51) Int. Cl. G06Q 30/02; G06Q 50/00

(52) U.S. Cl. CPC G06Q 30/0202; G06Q 50/01

(57) ABSTRACT

A method for performance forecasting of an asset, the method comprising: collecting data associated with an asset; aggregating the data associated with the asset over a predetermined time; calculating a sentiment score of the asset; constructing a forecast of the sentiment score; constructing historical and forecasting data based on the sentiment score; calculating a predication of a daily return of the asset; calculating a historical fitted value of daily return of the asset; constructing a simulation forecast for a future time period, and estimating a return on the asset over the future time period; generating a signal of the asset; ranking the asset based on the signal; and generating a portfolio of at least one asset.

### CROSS-REFERENCE TO RELATED APPLICATIONS

This application is a continuation-in-part (and claims the benefit of priority under 35 USC 120) of U.S. application No. 62/878,929 filed Jul. 26, 2019, U.S. application No. 62/878,936 filed Jul. 26, 2019, and U.S. application Ser. No. 16/939,874 filed Jul. 27, 2020. The disclosure of the prior applications is considered part of (and is incorporated by reference in) the disclosure of this application.

### BACKGROUND

This disclosure generally relates to the performance forecasting of various assets, and more specifically to the performance forecasting of various assets based on various form of social media and publications.

Conventionally, many different approaches have been taken to predict how stock and other asset prices will move in the future. These varying approaches often have tended to reflect the forecasters' different philosophies, different investment time frames, different levels of knowledge and skill, and different access to relevant information.

Probably the most widely accepted version of this hypothesis holds that the market always accurately prices each asset based on all publicly available information. By accepting this assumption, it can be shown mathematically that many of the difficult problems of asset price forecasting disappear, and that the most effective asset management techniques involve little more than managing portfolios so as to diversify away as much risk as possible and then controlling the remaining risk so as to balance an acceptable level of risk against a desired rate of return. Two of the most popular models based on the efficient markets hypothesis have been the Capital Asset Pricing Model (CAPM) and the Arbitrage Pricing Model (APM).

While at one time nearly universally accepted, at least in the academic community, the efficient markets hypothesis has come under increasing criticism. Thus, the need to individually evaluate the pricing of stocks and other assets is becoming increasingly apparent. Moreover, even to the extent that the efficient market hypothesis holds, better risk measures are desirable in implementing the techniques suggested thereby. It is noted that, in addition to generating wealth for the individual, accurate asset pricing analysis has highly important implications with respect to efficient allocation of society's resources.

It is also becoming apparent that the amount of publicly (and in some instances privately) information has increased tenfold since these theories were developed. Therefore, to take the available information and effectively use it, is becoming nearly impossible based on the creation, publication, and obsoletion of the information with new information being generated.

Therefore, it is desired for a method, computer program, or computer system to analyze the available information, process the information based on the asset, and determine performance forecasts for the asset in real time.

### SUMMARY

In a first embodiment, the present invention is a method for performance forecasting of an asset, the method comprising: collecting, by at least one processor, data associated with an asset; aggregating, by at least one processor, the data associated with the asset over a predetermined time; calculating, by at least one processor, a sentiment score of the asset; constructing, by at least one processor, a forecast of the sentiment score; constructing, by at least one processor, historical and forecasting data based on the sentiment score; calculating, by at least one processor, a predication of a daily return of the asset; calculating, by at least one processor, a historical fitted value of daily return of the asset; constructing, by at least one processor, a simulation forecast for a future time period, and estimating a return on the asset over the future time period; generating, by at least one processor, a signal of the asset; ranking, by at least one processor, the asset based on the signal; and generating, by at least one processor, a portfolio of at least one asset.

In a second embodiment, the present invention is a computer program product for performance forecasting of an asset, the computer program product comprising: a computer non-transitory readable storage medium having program instructions embodied therewith, the program instructions executable by a computing device to cause the computing device to: program instruction to collect data associated with assets, wherein the data includes social media data and assets value data; program instructions to calculate a sentiment score of the assets; program instructions to construct a forecast of the sentiment score over a predetermined time; program instructions to construct historical and forecasting data based on the sentiment score of the assets over a predetermined time period; program instructions to calculate a predication of a return of the assets; and program instructions to collect data and compare the collected data to the predication.

In a third embodiment, the present invention is a system for performance forecasting of an asset, the computer program product comprising: a CPU, a computer readable memory and a computer non-transitory readable storage medium associated with a computing device: collecting data associated with an asset, wherein the data includes social media data and asset value data; aggregating the data associated with the asset over a predetermined time; calculating a sentiment score of the asset based on the aggregated data associated with the asset; constructing a forecast of the sentiment score over a predetermined time based on the sentiment score; constructing historical and forecasting data based on the sentiment score of the asset over a predetermined time period; calculating a predication of a return of the asset; generating a signal of the asset; ranking the asset based on the signal; and formulating portfolios based on the ranking of the asset.

### BRIEF DESCRIPTION OF THE DRAWINGS

Referring now to the drawings in which like reference numbers represent corresponding parts throughout:

FIG. 1 depicts a block diagram depicting a computing environment according to an embodiment of the present invention.

FIG. 2 depicts a cloud computing node according to an embodiment of the present invention.

FIG. 3 depicts a cloud computing environment according to an embodiment of the present invention.

FIG. 4A depicts a portion of a flowchart of the operational steps taken by a system for the determination of asset valuation through social media, in accordance with an embodiment of the present invention.

FIG. 4B depicts a portion of a flowchart of the operational steps taken by a system for the determination of asset valuation through social media, in accordance with an embodiment of the present invention.

FIG. 4C depicts a portion of a flowchart of the operational steps taken by a system for the determination of asset valuation through social media, in accordance with an embodiment of the present invention.

FIG. 4D depicts a portion of a flowchart of the operational steps taken by a system for the determination of asset valuation through social media, in accordance with an embodiment of the present invention.

FIG. 4E depicts a portion of a flowchart of the operational steps taken by a system for the determination of asset valuation through social media, in accordance with an embodiment of the present invention.

FIG. 4F depicts a portion of a flowchart of the operational steps taken by a system for the determination of asset valuation through social media, in accordance with an embodiment of the present invention.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

The present invention generates performance forecasts for an asset based on opinions expressed in written or oral form on social media, news outlets, financial reporting, websites, television, radio, transcripts, and any other form of communication, both publicly and privately. The invention models the abnormal performance of an asset in excess of a benchmark portfolio as a function of investor sentiment and keywords associated with the asset. Keywords about an asset are extracted from the data using a learning capable algorithm. Investor sentiment measures the overall attitude of investors relative to the asset and is also computed via the algorithm. These forecasts can be used to construct measures of expected level, expected return, volatility, uncertainty, or any other performance statistic of an asset.

The present invention aims to automate the research, understanding, and predictive outcome for an entity using social media, news articles, reports, transcripts, and any other form of written and oral communication in private or public.

The present invention assigns economic value to specific keywords and chatter about the asset. Using a methodology that relates investor sentiment measures to financial performance measures over arbitrary time horizons; that forecasts financial performance for different assets based on asset characteristics, macroeconomic factors, and opinions expressed about the asset; that learns about the economic significance of words, events, actions, and inactions; that learns about the economic significance of investor sentiment.

Through the identification of keywords that are economically relevant for forecasting financial performance measures across different assets from a collection of keywords. The identification of keywords that are not economically relevant for forecasting financial performance measures across different assets from a collection of keywords. The identification of events that are economically relevant for forecasting financial performance measures across different assets from a collection of events. The identification of events that are not economically relevant for forecasting financial performance measures across different assets from a collection of events. The identification of actions that are economically relevant for forecasting financial performance measures across different assets from a collection of actions. The identification of actions that are not economically relevant for forecasting financial performance measures across different assets from a collection of actions. The identification of inactions that are economically relevant for forecasting financial performance measures across different assets from a collection of inactions. The identification of inactions that are not economically relevant for forecasting financial performance measures across different assets from a collection of inactions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

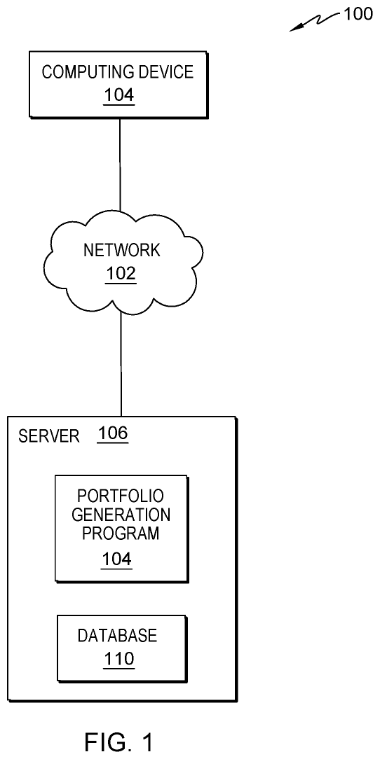

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, computing device 104, server 106, portfolio generation program 108, and database 110. Computing environment 100 may include additional servers, computers, or other devices not shown.

Network 102 may be a local area network (LAN), a wide area network (WAN) such as the Internet, any combination thereof, or any combination of connections and protocols that can support communications between computing device 104, and server 106 in accordance with embodiments of the invention. Network 102 may include wired, wireless, or fiber optic connections.

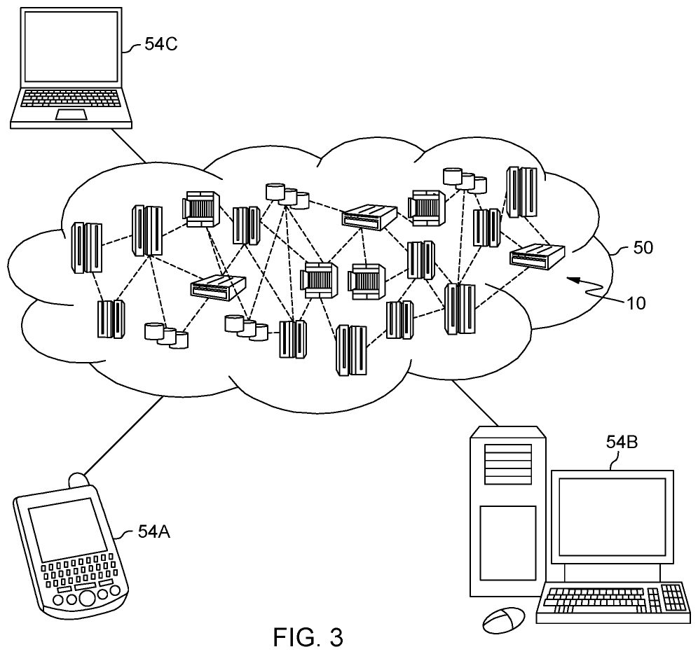

Computing device 104 may be a management server, a web server, or any other electronic device or computing system capable of processing program instructions and receiving and sending data. In other embodiments, computing device 104 may be a laptop computer, tablet computer, netbook computer, personal computer (PC), a desktop computer, or any programmable electronic device capable of communicating with server 106 via network 102. In other embodiments, computing device 104 may be a server computing system utilizing multiple computers as a server system, such as in a cloud computing environment. In one embodiment, computing device 104 represents a computing system utilizing clustered computers and components to act as a single pool of seamless resources. computing device 104 may include components, as depicted, and described in further detail with respect to FIG. 3.

Server 106 may be a management server, a web server, or any other electronic device or computing system capable of processing program instructions and receiving and sending data. In other embodiments, server 106 may be a laptop computer, tablet computer, netbook computer, personal computer (PC), a desktop computer, or any programmable electronic device capable of communicating via network 102. In one embodiment, server 106 may be a server computing system utilizing multiple computers as a server system, such as in a cloud computing environment. In one embodiment, server 106 represents a computing system utilizing clustered computers and components to act as a single pool of seamless resources. In the depicted embodiment database 110 is located on server 106. Server 106 may include components, as depicted, and described in further detail with respect to FIG. 3.

Portfolio generation program 108 operates to perform the analysis on the assets (e.g. cryptocurrencies and other commodities) to determine how social media is affecting the evaluation of these assets and predicting assets which will have high or low returns in the future and providing predictions to which assets to buy and sell and when. In the depicted embodiment, portfolio generation program 108 utilizes network 102 to access the computing device 104 and the server 106 and communicates with database 110. In one embodiment, portfolio generation program 108 resides on server 106. In other embodiments, portfolio generation program 108 may be located on another server or computing device, provided portfolio generation program 108 has access to database 110.

Database 110 may be a repository that may be written to and/or read by portfolio generation program 108. Information gathered from structured data source 110 and/or unstructured data source 112 may be stored to database 110. Such information may include previous scores, audio files, textual breakdowns, facts, events, and contact information. In one embodiment, database 110 is a database management system (DBMS) used to allow the definition, creation, querying, update, and administration of a database(s). In the depicted embodiment, database 110 resides on server 106. In other embodiments, database 110 resides on another server, or another computing device, provided that database 110 is accessible to portfolio generation program 108.

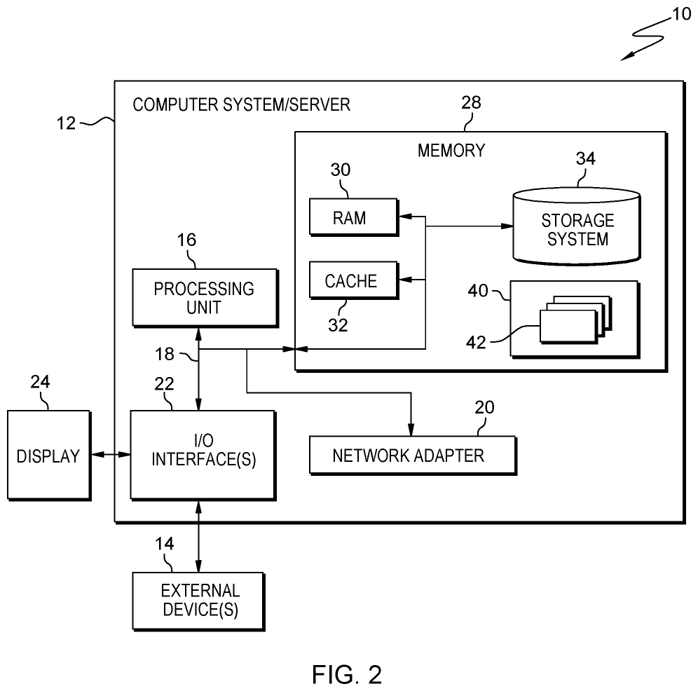

Referring now to FIG. 2, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 2, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, and laptop computer 54C may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-C shown in FIG. 2 are intended to be illustrative only and that computing nodes 10 and cloud computing environment 50 can communicate with any type of computerized device over any type of network and/or network addressable connection (e.g., using a web browser).

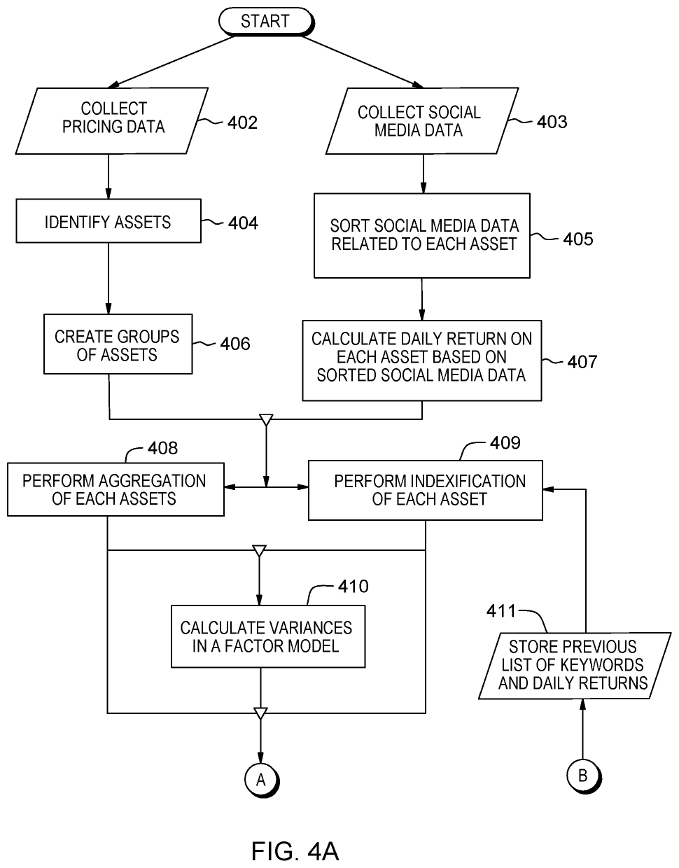

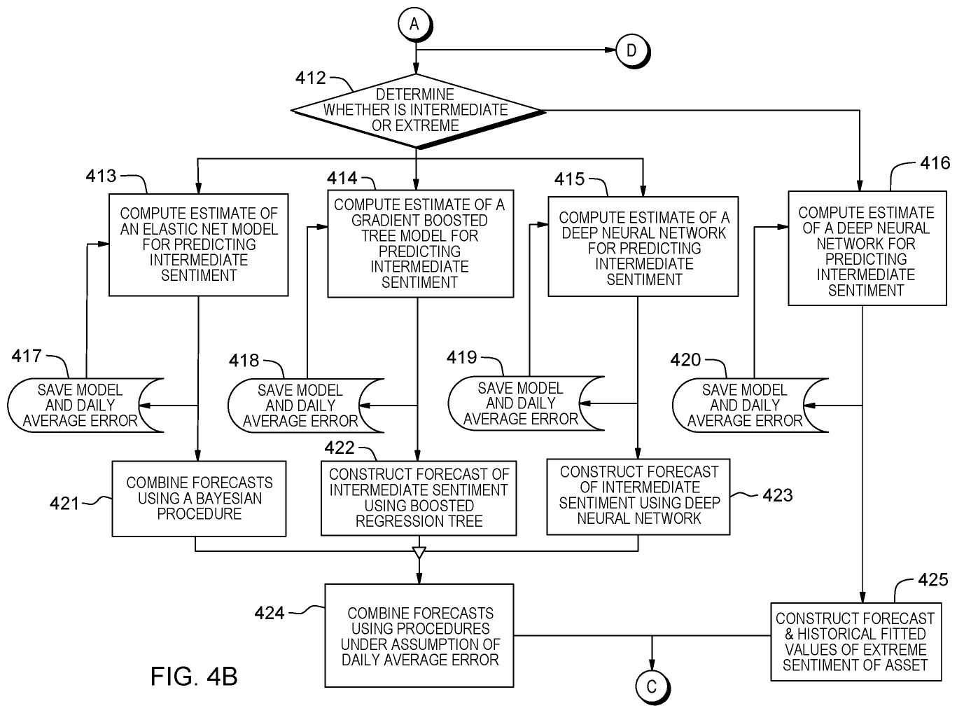

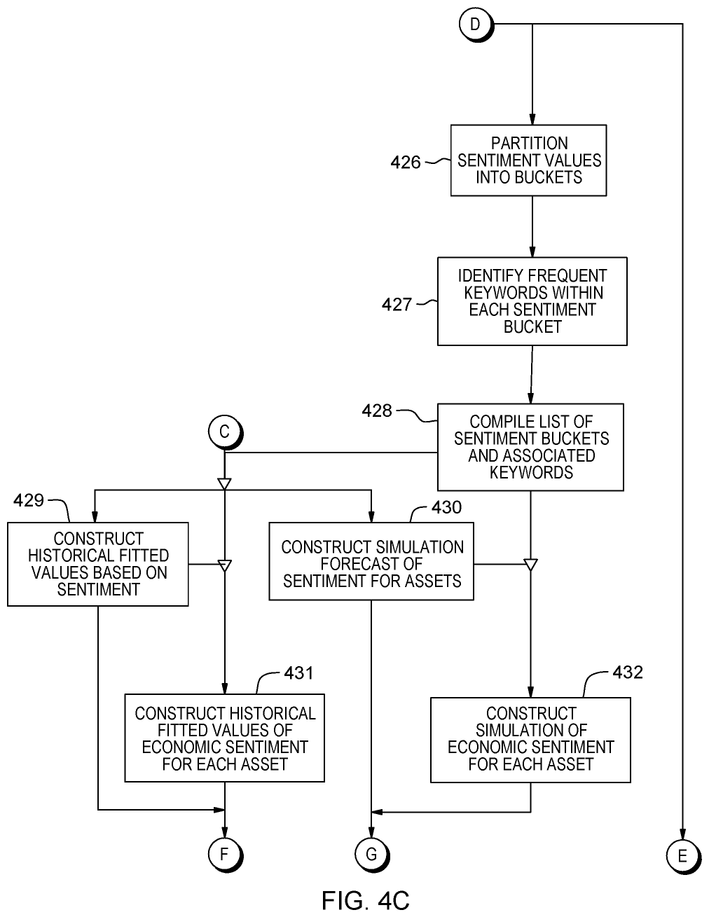

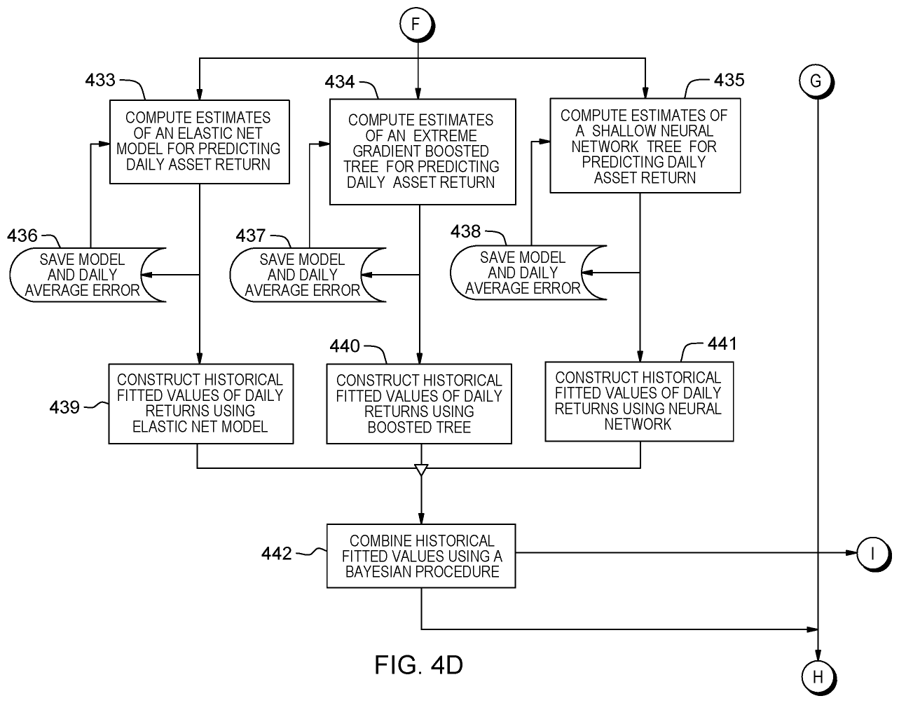

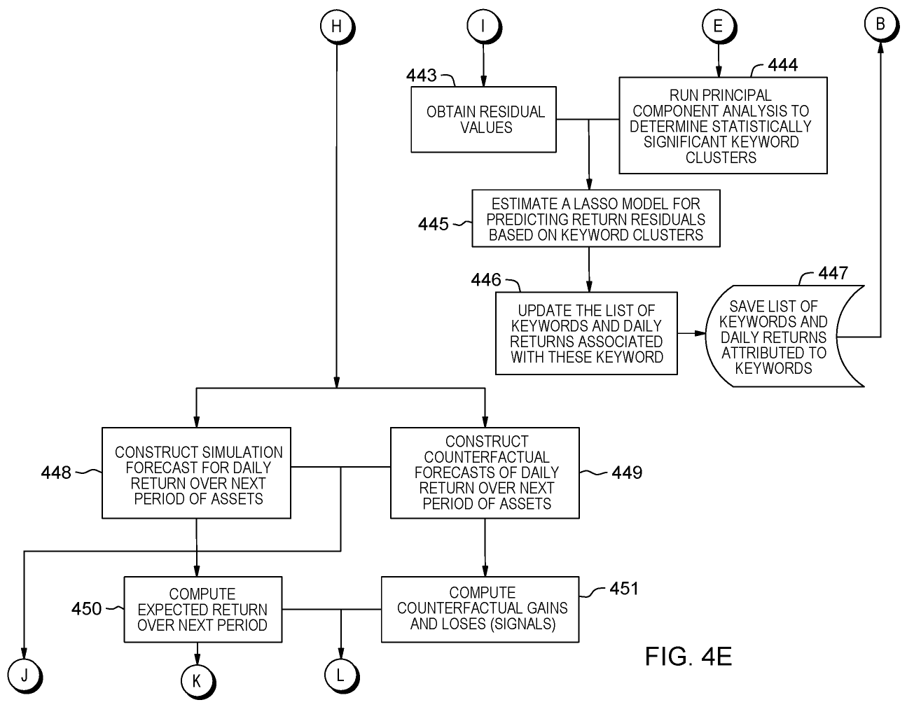

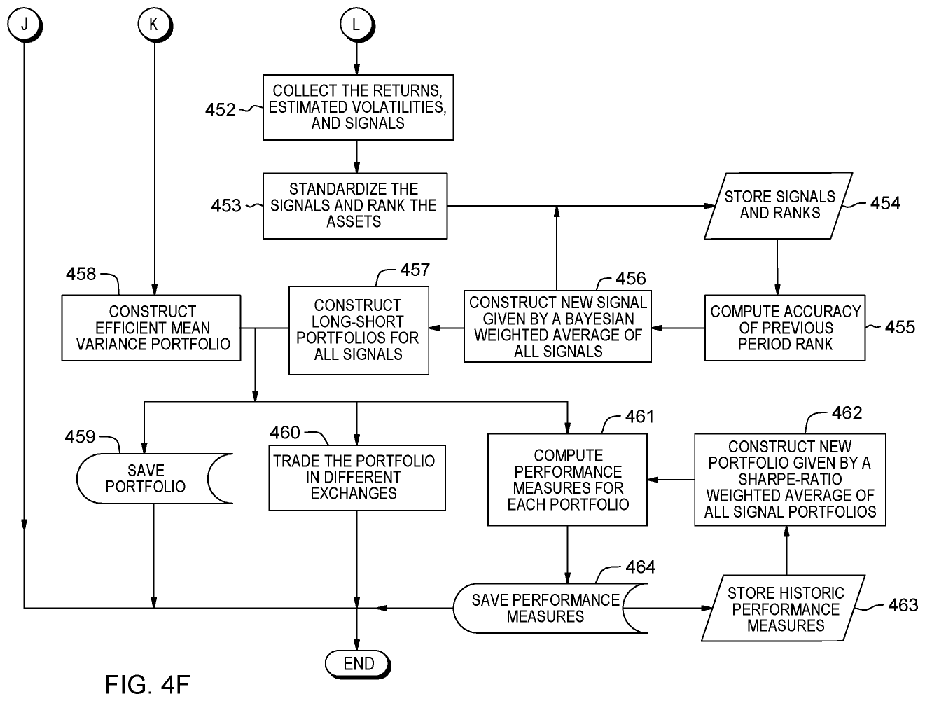

FIGS. 4A-4F depicts flowchart 400 depicting the method according to the present invention. The method(s) and associated process(es) are now discussed, over the course of the following paragraphs, with extensive reference to FIG. 2, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 402 and 403, the program, system, and method collect various pricing data and social media data related to a predetermined asset. The social media may be collected through a plurality of social media accounts or platforms. Contributors from Twitter, for example, send a message (e.g., a tweet) containing a prediction or a piece of information related to an asset. The system searches for keywords and symbols (such as a hashtag, “#,” or a dollar sign, “$”) within the message. This information is stored and is compared to actual data over various time periods, and a rating is assigned to the contributor based on the accuracy of the prediction. T system classifies anyone that authors certain messages, such as social media messages, that are deemed to have made information related to the asset either positive or negative. In some embodiments, the system separates the persons posting the social media as internal or external to determine if the individual as previous knowledge of the asset or not based on the disclosure. An internal person is a user who would have preferential information about an asset. The system also collects the various pricing data associated with the asset (e.g. stock, currency, crypto currency, etc.). This data may be in the form of returns on the asset, market capitalization of the asset, trading volume of the asset, or the like. This first set of data is associated with the financial aspects of the asset.

In step 404, the system identifies a set number (e.g. 100, 50, 25, etc.) of assets in a similar space (e.g. cryptocurrencies, renewable energy, oil, etc.) based on various characteristics and divide the assets into specific groups.

In step 406, the system creates a set number of groups of the assets based on a predetermined set of requirements. For example, the system may create five (5) groups of assets based on a set of categorical differentiators of the assets. For example, the market capitalization of each asset and the previous seven day return of the asset and group the 100 assets into these five groups based on the group's identifiers. The groups identifiers may be based on numerical values of the categorical differentiators or other factors.

In step 405 the system collects various pieces of social media data related to the asset. This may include, but not limited to, articles, publications, posts, opinion, tweets, or the like from a variety of people or entities. The program is able to collect and determine the number of publications of the data day-by-day, identify keywords and the positive or negative aspect of these words, sentiment of the publications, and emotions associated with the publications. The publications are then analyzed in relation to the daily return of that asset, generating an economic sentiment score. This step is repeated at periodic and predetermined intervals. In some embodiments, this step is completed multiple times a day, every day.

This can include the number of reports published within a predetermined time period about the asset, the frequency of keywords used in the reports, the frequency of positive and negative keywords, sentiment, and emotions associated with the publications, posts, and social media generated about the asset. The system utilized proprietary algorithms and computer learning modules to analyze the social media and publications for these aspects.

In step 407, the system computes daily returns of the asset relative to the associated keywords and extracted data from the publications and social media posts. This is a form of business/economic sentiment. The measurement of the optimism and pessimism of the asset. In some embodiments, an economic sentiment indicator score is generated to provide a value associated with the optimism or pessimism related to the asset.

In steps 408 and 409 the system aggregates and indexes the pricing data and the social media data. The system aggregates the pricing and social media data for the group of assets previously identified over a set period of time (e.g. a year, month, week, etc.). The system also indexes each asset by computing the statistics for the capitalization weighted index. The capitalization weighted index is a stock market index whose components are weighted according to the total market value of their outstanding shares. Every day an individual stock's price changes and thereby changes a stock index's value.

In step 410, the system creates a factor model. Wherein the factor model is a comparison of each group created in step 304 and calculating the alpha, beta, and residual variances for each group. The alpha relates to the excess return on an investment, the beta related to the relative volatility of the group, and the residual is a unexpected/random component/return which is selected based on the systems preexisting data or computer leaning technology.

In step 412, the system generates a sentiment score. The sentiment score is calculated and analyzed to determine the sentiment of the collected data from steps 402 and 403. Based on the calculated sentiment score the system determines if the score is extreme or intermediate. In the event that the system determines that the sentiment score is extreme (in a positive or negative aspect) the system estimates (step 416) a penalized multinomial regression for predicting extreme sentiment based on the asset and index characteristics and factor model estimates, and updates the previous estimates via exponential weighting of the estimate. All of this data is collected, stored, and compared to the previous daily averages to calculate an error of the previous daily estimate to the actual values (steps 420). In some embodiments, this error is averaged over a time period once adequate data is collected.

If the sentiment is viewed as normal the program uses various processing techniques (e.g. elastic net modeling, gradient boosted tree, deep neural network, or other known types of machine learning models and techniques) to predict the sentiment value of the data based on the index, aggregate, and factor model estimates. In the event that the system determines the sentiment score to be intermediate (not extreme), the system computes an estimate of an elastic net model (step 413) for predicting intermediate sentiment based on the asset and index characteristics and the factor model estimates and updates the previous estimate via the exponential weighting. The system also updates the previous estimate of the gradient boosted tree (step 414) for predicting the intermediate sentiment based on the asset, the index characteristics, and the factor model estimates. The system also updates the previous estimate of a deep neural network (step 415) with predictive processing for the intermediate sentiment based on the asset, the index characteristics, and the factor model estimates. All of this data is collected, stored, and compared to the previous daily averages to calculate an error of the previous daily estimate to the actual values (steps 417, 418, 419 respectively). In some embodiments, this error is averaged over a time period once adequate data is collected.

The sentiment scores are partitioned (Step 426) into repositories (buckets) related to different sentiment scores. These buckets assets are collected with posts or publications which, after performing a sentiment analysis on the post or publication fall within that bucket's sentiment score, and detecting and identifying (step 427) the frequent keywords within those posts within each sentiment score. This data is then used to compile (step 428) lists of different keywords associated with each bucket. In some embodiments, the system takes all of the collected sentiment data and sorts it into different categories. These categories can be positive, neutral, and negative, for example. The program then identifies assets that are identified within the publication and determine the most frequent keywords used in the publication. The program then compiles a list of keywords and their associated sentiment.

For the extreme and intermediate sentiment calculations, the data is stored including a calculated average error under the assumption that extreme and intermediate sentiment follow a multinomial distribution, which is used for future calculations of the estimates.

These estimates are storied daily or at other predetermined intervals and are used in the next iteration of the computations to further improve the accuracy of the computations. Through the use of the previously calculated estimates, the program is able to better and more accurately assess the sentiment of the publication based on the performance of the asset. The program then constructs a forecast for the asset based on the historically fitted values using each of the processing techniques (steps 421, 422, and 423, respectively). Each of the constructed forecasts are then combined (step 424) and using a Bayesian procedure, the average error is distributed over the data for correction. A forecast and historical fitted value of the intermediate sentiment score is created based on the elastic net model, the boosted regression tree, and the deep neural net calculation. In some embodiments, one, a combination of two, or all three of these calculations and estimate methods may be used based on the asset and desired limitations. A forecast and historical fitted value are calculated/constructed (step 425) in the extreme sentiment cases over a future period of time to determine if the extreme sentiment score changes.

The system constructs values of historical data using both the intermediate and extreme sentiment scores in accordance with an estimated multinomial distribution of the extreme and intermediate sentiment scores. The system also constructs a simulation forecast(s) (steps 430 and 432) of the sentiment of the asset over a predetermined period of time. This simulation is performed by sampling with replacement data from the estimated multinomial distribution of the extreme and intermediate sentiment of the asset publications. Additionally, historic fitted values of the economic sentiment scores and values for each asset from previously collected data is constructed (step 429 and 431).

Using these historical fitted values and simulation forecasts, the system creates estimate for future fitted values and simulation forecasts for the following time period (next day, week, month year, etc.) through a sampling of the keywords within the buckets or categories associated with the historical fitted sentiment scores.

The system computes an estimate of an elastic net model for predicting a daily (or over a predetermined time period) returns on the asset based on the index characteristics, the factor model estimates, the fitted sentiments and the economic sentiments (step 433). The system computes an estimate of an extreme gradient boosted tree for predicting a daily (or over a predetermined time period) returns on the asset based on the index characteristics, the factor model estimates, the fitted sentiments and the economic sentiments (step 434). The system computes an estimate of a shallow neural network for predicting a daily (or over a predetermined time period) returns on the asset (step 435). All of this data is collected, stored, and compared to the previous daily averages to calculate an error of the previous daily estimate to the actual values (steps 436, 437, 438 respectively). In some embodiments, this error is averaged over a time period once adequate data is collected.

These computations are based on the index characteristics, the factor model estimates, the fitted sentiments and the economic sentiments, or a combination of the three estimates above. This data is then saved and at the conclusion of the period of time an error estimate is calculated, and the previous period estimates are used in the estimates for the next period. These estimates are storied daily or at other predetermined intervals and are used in the next iteration of the computations to further improve the accuracy of the computations. Through the use of the previously calculated estimates, the program is able to better and more accurately assess the sentiment of the publication based on the performance of the asset.

Based on the calculated estimates, the system constructs historical fitted values (steps 439, 440, and 441 respectively), the system uses the processing techniques (e.g. elastic net modeling, gradient boosted tree, deep neural network, or other known types of machine learning models and techniques) The system used at least one of these historical fitted values and combines (step 442) the fitted values. In some instances, using a Bayesian procedure, the average error is distributed over the data for correction. The Bayesian procedure under the assumption that daily average error is normally distributed (weights are proportional to the probability that a model has zero error).

The residual values from the procedure are obtained (step 443) to show the different between the observed values and the predicted values. While the keyword buckets are analyzed to determine which of the keywords or buckets are statistically related (e.g. forming clusters or relations between the keywords) based on the previously collected data (step 444).

These residual values and the keyword clusters which are calculated data and the set of keywords are input into a shrinkage and selection operation in order to enhance the prediction accuracy and interpretability of the statistical model it produces. The program then updates the set of keywords with any new data collected from the residual data.

The residual values (realized minus fitted returned) from the now updated model with the determined cluster of keywords that are statistically related based on the buckets/categories, and use (step 445) a regression analysis method (e.g. least absolute shrinkage and selection operator (LASSO)) to estimate the return residual as a function of the keyword clusters of each individual post or publication, and then update the list of keywords.

From the estimate model, the list of keywords (and the associated buckets, and clusters) are updated (Step 446) and the daily returns associated with these keywords is adjusted to accommodate the newly calculated estimations. All of this data is collected, stored, and compared to the previous daily averages to calculate an error of the previous daily estimate to the actual values (steps 447). In some embodiments, this error is averaged over a time period once adequate data is collected. This stored list of keywords and daily returned associated with the keywords is stored (step 411) and used in the indexification of each asset (Step 409)

The system using the combined historical fitted values and the constructed simulation forecast of the sentiment for the assets and the constructed simulation of the economic sentiment forecast for each asset, constructs (step 448) a simulation forecast of daily returns over the next time period and constructs (step 449) of counterfactual forecasts of daily returns. The circumstances of the counterfactual forecast are adjustable and modifiable based on the desired set of facts or model agnostic.

The construction of the simulation forecasts of a daily (or over a predetermined time period) return for the set number of assets by sampling from each of the return models using forecasts or sentiment and economic sentiment, the asset and index characteristics, and the factor model estimates. This simulated forecast is used to compute (step 450) an expected return over a future time period and determine a volatility score associated with the expected return based on the forecast calculation. The calculated counterfactual forecast is used to compute (step 451) expected gains and loses of the assets over the next period. For a list of key characteristics, construct counterfactual forecasts of daily return over the predetermined time period of the asset by sampling from each return model under the assumption that an asset deviates from its current value of the characteristic and instead takes on the average characteristic value in the portfolio of comparable assets. All other characteristics are kept the same as in the data used to construct forecasts. Based on the counterfactual construction, an estimated gains and losses are computed if the asset becomes more similar to the other compared assets.

Using the expected return, estimated volatility, and counterfactual gains and losses of the asset a signal is formed (step 452). The signal is then standardized (step 453) through the removal of the cross sectional mean of the signal and dividing the cross sectional standard deviation of the signal. This is performed in conjunction with the ranking the assets in decreasing order of standardized signal. This data is stored (step 454) and a computation of the previous period's accuracy is ranked with previous accuracy calculations (step 455).

The rank of the present period of signals is compared with the previous periods ranking to determine any differences or similarities between the two ranking sets. Previous ranking are averaged and a new signal is constructed (step 456) given by a weighted average of all signals, where the weights are computed via a Bayesian rule where the probability is proportional the likelihood that the model ranked the assets correctly on any given day (use a Wilcox test to determine the accuracy of a rank and update previous day's model probabilities).

A signal portfolio is constructed by going long on the highest ranked assets and short on the worst ranked assets.

The program also constructs (Step 458) an efficient mean-variance portfolio according to the asset's estimated expected return and volatility.

For each signal, a portfolio is created (step 457) for either short term or long term that show the “best” ranked assets and “worst” ranked assets to either buy or sell. Additionally, a portfolio is constructed using Markowitz design (mean-variance) in accordance with the estimated return and volatility.

The efficient mean variance portfolio(s) and the long and/or short portfolio(s) are stored (Step 459) and are used for trading (step 460) in different exchanges. Once the portfolio is created, the portfolio is monitored to determine (461) the overall performance of each portfolio and each asset. This performance is stored (Step 464) and compared with historic data of the specific portfolio, of each asset within the portfolio, of various other portfolios (based on predetermined factors) to determine a comparison of the various performance metrics. These comparisons are then used to formulate new portfolios (step (462) of the highest yielding or most profitable assets and/or portfolios to trade.

All of these portfolios that are created can be traded, can be further analyzed, wherein performance measures for each portfolio is calculated. Where the performance measures of each portfolio are calculated, the program can construct a new portfolio that has the weighted average of all portfolios created, wherein the weight is proportional to various ratios of the other portfolios used in the calculation.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

What is claimed is:

1. A method for performance forecasting of an asset, the method comprising:
collecting, by at least one processor, data associated with an asset;
aggregating, by at least one processor, the data associated with the asset over a predetermined time;
calculating, by at least one processor, a sentiment score of the asset;
constructing, by at least one processor, a forecast of the sentiment score;
constructing, by at least one processor, historical and forecasting data based on the sentiment score;
calculating, by at least one processor, a predication of a daily return of the asset;
calculating, by at least one processor, a historical fitted value of daily return of the asset;
constructing, by at least one processor, a simulation forecast for a future time period, and estimating a return on the asset over the future time period;
generating, by at least one processor, a signal of the asset;
ranking, by at least one processor, the asset based on the signal; and
generating, by at least one processor, a portfolio of at least one asset.

2. The method for performance forecasting of an asset, of claim 1, further comprising, calculating, by at least one processor, an expected return over the future time period.

3. The method for performance forecasting of an asset, of claim 1, further comprising, constructing, by at least one processor, a counterfactual forecast of a return of the asset.

4. The method for performance forecasting of an asset, of claim 3, further comprising, calculating, by at least one processor, an expected return and lose over the future time period.

5. The method for performance forecasting of an asset, of claim 1, further comprising, calculating, by at least one processor, an efficient mean variance portfolio and a long-short portfolio of the asset and other similar assets.

6. The method for performance forecasting of an asset, of claim 1, further comprising, monitoring, by at least one processor, the portfolio based on the assets returns.

7. The method for performance forecasting of an asset, of claim 6, further comprising, adjusting the portfolio based on return and ranking of the assets.

8. A computer program product for performance forecasting of an asset, the computer program product comprising:
a computer non-transitory readable storage medium having program instructions embodied therewith, the program instructions executable by a computing device to cause the computing device to:
program instruction to collect data associated with assets, wherein the data includes social media data and assets value data;
program instructions to calculate a sentiment score of the assets;
program instructions to construct a forecast of the sentiment score over a predetermined time;
program instructions to construct historical and forecasting data based on the sentiment score of the assets over a predetermined time period;
program instructions to calculate a predication of a return of the assets; and
program instructions to collect data and compare the collected data to the predication.

9. The computer program product of claim 8, wherein at least two processing techniques are used to calculate the intermediate sentiment scores.

10. The computer program product of claim 8, wherein the forecast calculation uses at least two processing techniques to calculate at least two differing forecast values.

11. The computer program product of claim 8, further comprising, program instruction to sort the sentiment data into categories.

12. The computer program product of claim 9, further comprising, program instruction to identify the frequency of keywords within each category.

13. The computer program product of claim 8, further comprising, program instruction to calculate a signal related to the assets.

14. The computer program product of claim 13, wherein the signal is recalculated over each predetermined future period of time for the assets.

15. The computer program product of claim 8, further comprising, program instruction to standardize the signal and a ranking of the assets.

16. A system for performance forecasting of an asset, the computer program product comprising:
a CPU, a computer readable memory and a computer non-transitory readable storage medium associated with a computing device:
collecting data associated with an asset, wherein the data includes social media data and asset value data;
aggregating the data associated with the asset over a predetermined time;
calculating a sentiment score of the asset based on the aggregated data associated with the asset;
constructing a forecast of the sentiment score over a predetermined time based on the sentiment score;
constructing historical and forecasting data based on the sentiment score of the asset over a predetermined time period;
calculating a predication of a return of the asset;
generating a signal of the asset;
ranking the asset based on the signal; and
formulating portfolios based on the ranking of the asset.

17. The system of claim 16, further comprising, computing the performance of the portfolios.

18. The system of claim 16, further comprising, constructing new portfolios based on the computed performance of the portfolio.

19. The system of claim 16, wherein the calculated predication of a return of the asset based on the forecasting of the sentiment score, the historical data, and the forecasting data.

20. The system of claim 65, further comprising, calculating an efficient mean variance portfolio.
